(19) United States
(12) Patent Application Publication
(10) Pub. No.: US 2015/0345125 A1
(43) Pub. Date: Dec. 3, 2015

(54) Drainage Collection Box Device

(71) Applicants: Richard Gazlay, Tampa, FL (US); Mark Mattison, Odessa, FL (US)

(72) Inventors: Richard Gazlay, Tampa, FL (US); Mark Mattison, Odessa, FL (US)

(21) Appl. No.: 14/729,881

(22) Filed: Jun. 3, 2015

Related U.S. Application Data
(60) Provisional application No. 62/007,111, filed on Jun. 3, 2014.

(51) Int. Cl. E03F 5/14; B01D 35/28; B01D 35/02

(52) U.S. Cl. CPC E03F 5/14; B01D 35/02; B01D 35/28

(57) ABSTRACT

A drainage collection box device for automatically removing leaves and other debris from a collection box of a drainage system. The drainage collection box device includes a container having a base, an open upper end, one or more sidewalls, and one or more openings disposed on the sidewalls. Each opening of the container can be connected to a pipe of a drainage system, wherein water and debris travel into the container therefrom. The device further includes a lid pivotally secured to the upper end of the container and a pair of baffles disposed on the sides of the lid. As the water level rises to the top of the container, the pressure from the rising water and debris push the lid to an open configuration, wherein the baffles direct the water and debris to flow out of the front upper end of the container.

### CROSS REFERENCE TO RELATED APPLICATION

This application claims the benefit of U.S. Provisional Application No. 62/007,111 filed on Jun. 3, 2014. The above identified patent application is herein incorporated by reference in its entirety to provide continuity of disclosure.

### BACKGROUND OF THE INVENTION

### Field of the Invention

The present invention relates to drainage systems. More specifically, the present invention provides a drainage collection box device comprising a lid pivotally secured to a container, wherein the container includes one or more openings adapted to be secured to one or more underground pipes of a drainage system so as to allow water and debris to flow into the container from beneath the surface of the ground. The level of water and debris rise to the top of the container so as to lift the lid to an open configuration in order for the debris and water to be removed therefrom and released above ground at a desired location.

During periods of heavy rainfall, water accumulates causing flooding on rooftops, around buildings, houses, and the like. The flooding results in damage to building foundations, creates erosion, and penetrates cracks in one's home, thereby leading to leaks and water damage. Therefore, drainage systems, such as gutters and French drains, are required to divert and prevent water from accumulating in such places. However, many drainage systems are not equipped to accommodate the extra volume of water that travels from building roofs, gutters, sidewalks, and the like. Furthermore, leaves and other debris accumulate in a drainage system resulting in blockage and other issues. In order to address the blocked drainage system, some individuals choose to frequently clean the debris therefrom. However, cleaning gutters and the like is dangerous if done by oneself due to the locations thereof. Some individuals choose to hire a professional to clean their drainage system, which is expensive.

Alternatively, other individuals install collection boxes into the drainage system in order to manage an increased water flow. However, conventional collection boxes do not comprise a lid that automatically opens during times of heavy water flow. As a result, debris that travels through the drainage system becomes stuck in the collection box until an individual manually removes the debris therefrom. Therefore, there exists a need in the prior art for a device that permits the automatic removal of debris from a drainage system.

It is submitted that the present invention substantially diverges in design elements from the prior art and consequently it is clear that there is a need in the art for an improvement to existing drainage collection box devices. In this regard the instant invention substantially fulfills these needs.

### SUMMARY OF THE INVENTION

In view of the foregoing disadvantages inherent in the known types of drainage collection box devices now present in the prior art, the present invention provides a new drainage collection box device wherein the same can be utilized for providing convenience for the user when removing debris and water from a collection box of a drainage system.

It is therefore an object of the present invention to provide a new and improved drainage collection box device that has all of the advantages of the prior art and none of the disadvantages.

It is another object of the present invention to provide a drainage collection box device comprising a container having a base, one or more sidewalls, and an open upper end, wherein the container is adapted to receive water and debris therein.

Another object of the present invention is to provide a drainage collection box device further comprising one or more openings disposed on the sidewalls of the container, wherein each opening is adapted to connect to a pipe from a drainage system and receive water and debris therefrom.

Yet another object of the present invention is to provide a drainage collection box device further comprising a lid pivotally secured to the open upper end of the container, wherein the lid is adapted to be automatically lifted by the pressure of the water and debris applied from beneath the lid.

Yet another object of the present invention is to provide a drainage collection box device further comprising a pair of baffles secured to the sides of the lid and adapted to direct the flow of water and debris to the front of the device for removal.

Yet another object of the present invention is to provide a drainage collection box device further comprising a cord having a first end and a second end, wherein the first end is secured to the upper end of the container and the second end is removably secured to the lid in order to limit the extent to which the lid can be opened.

Another object of the present invention is to provide a drainage collection box device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the drainage collection box device wherein the lid is in an open configuration.

FIG. 2 shows a rear perspective view of an embodiment of the drainage collection box device.

FIG. 3 shows a cross sectional view of an embodiment of the drainage collection box device.

FIG. 4 shows a perspective view of an embodiment of the drainage collection box device in use.

### DETAILED DESCRIPTION OF THE INVENTION

Reference is made herein to the attached drawings. Like reference numerals are used throughout the drawings to depict like or similar elements of the drainage collection box device. For the purposes of presenting a brief and clear description of the present invention, the preferred embodiment will be discussed as used for removing water and debris from a collection box of a drainage system. The figures are intended for representative purposes only and should not be considered to be limiting in any respect.

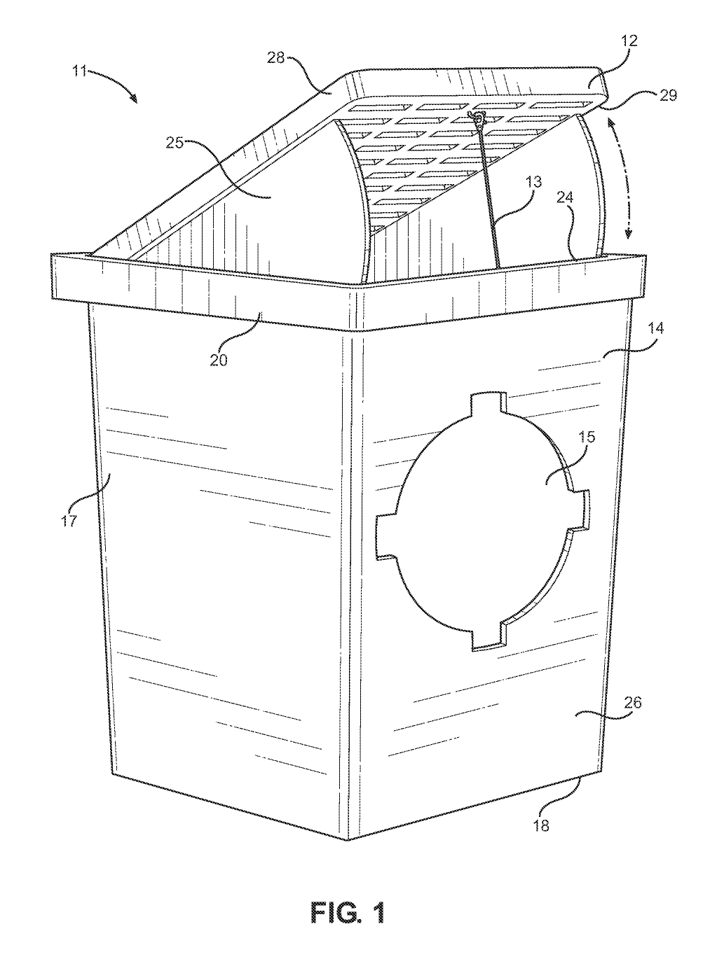

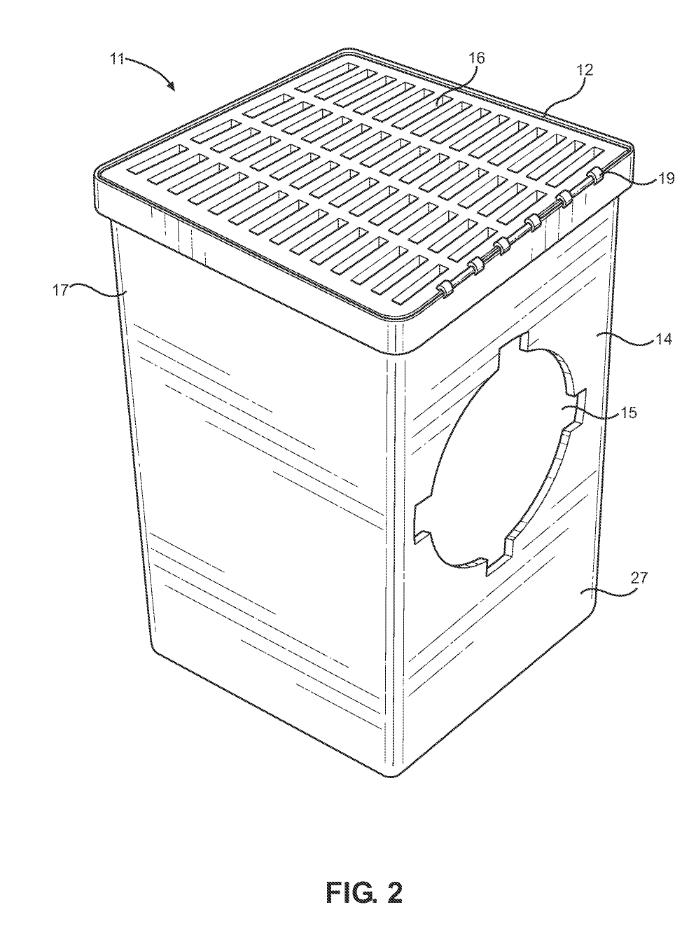

Referring now to FIGS. 1 and 2, there is shown a perspective view of an embodiment of the drainage collection box device wherein the lid is in an open configuration and a rear perspective view of an embodiment of the drainage collection box, respectively. The drainage collection box device 11 is adapted to connect to and become part of a drainage system, such as a gutter or French drain, wherein the drainage system receives water and debris therein as a result of rainfall and the like. The drainage collection box device 11 is adapted to remove the water and debris from the drainage system. The drainage collection box device 11 comprises a container 14 having a base 18, one or more sidewalls 17, and an open upper end 24, wherein the sidewalls 17 include a front wall 26 and a rear wall 27. In this embodiment, the container 14 is rectangular in shape. However, in other embodiments, the container 14 can be any suitable shape, such as cylindrical.

The container 14 further comprises one or more openings 15 disposed on the sidewalls 17 thereof. Each opening 15 of the container 14 is adapted to be secured to a pipe of the drainage system so as to allow water and debris to flow into the container 14, wherein the water and debris are then released via the open upper end 24 thereof. In the illustrated embodiment, an opening 15 is disposed on the front wall 26 and the rear wall 27. The openings 15 are substantially circular in shape, wherein each opening 15 comprises a plurality of slots disposed therearound. Each slot is adapted to receive a corresponding tab disposed on the periphery of a pipe. The tabs are adapted to align with the slots, wherein the shape of the tab prevents it from coming back through the slot once placed therein. In this way, the openings 15 are able to receive and secure to a pipe of a drainage system. In other embodiments, the openings 15 can be any suitable shape such as square, in order to accommodate various pipe fittings, shapes, and sizes. In some embodiments, an opening 15 is disposed on the base 18 of the container 14 in order to receive water and debris flow therethrough.

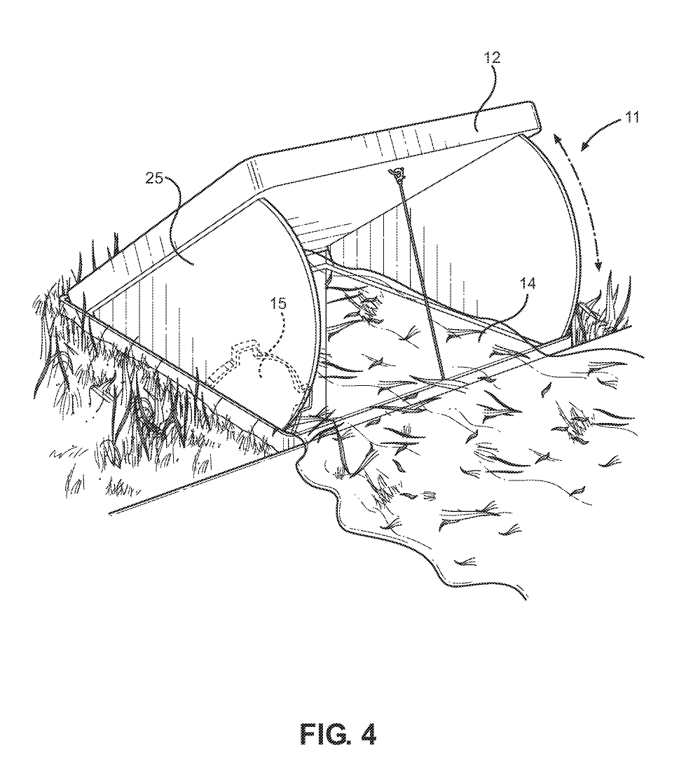

The drainage collection box device 11 further comprises a lid 12 pivotally secured to the open upper end 24 of the container 14, wherein the lid 12 includes a first side 28 and a second side 29. One or more hinges 19 are used to pivotally secure the lid 12 to the container 14, wherein the hinges 19 are disposed on the side of the rear wall 27. The lid 12 is substantially square in shape in order to fit within the square cross section of the container 14. In other embodiments, the lid 12 can be any suitable shape, such as a circle or rectangle, as long as it covers the open upper end 24 of the container 14. The lid 12 is adapted to provide protection against rodents, debris, and the like from entering the container 14 from the open upper end 24. In the illustrated embodiment, the lid 12 comprises a grate 16 in order to allow water to be removed through the grate 16 during an increased rate of water flow. However, in other embodiments, the lid 12 can be solid (as referenced in FIG. 4, 12) in order to accommodate a drainage system that does not experience an increased flow rate of water therethrough.

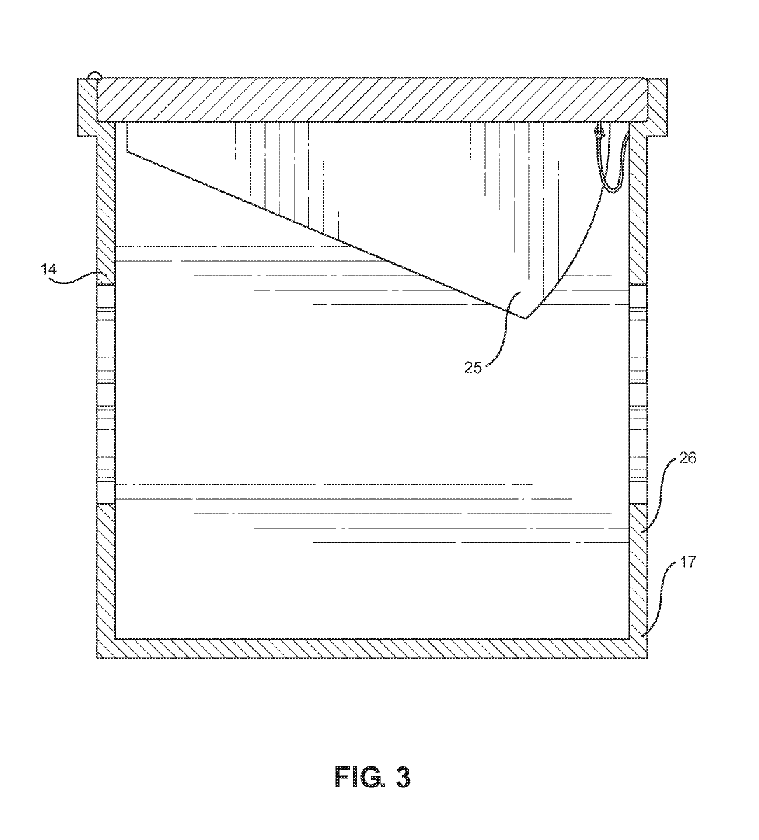

The lid 12 is adapted to automatically lift into an open orientation as a result of water and debris levels rising, thereby applying pressure against the lid 12 from therebeneath. In an open orientation, the lid 12 is angled so as to provide an open space between the container 14 and the lid 12. The open space is adapted to receive and remove water and debris flow from the container 14. Once the water flow rate decreases, the lid 12 returns to a closed configuration, wherein the lid 12 is horizontally disposed. In the illustrated embodiment, the lid 12 is disposed on a horizontal ledge 20 disposed around perimeter of the upper end of the interior of the sidewalls 17 of the container 14 (as referenced in FIG. 3, 20). The ledge 20 provides a support for the edges of a lid 12 to rest on. However, in other embodiments, the lid 12 can be supported by any suitable way, including resting on top of the edges of the open upper end 24 of the container 14. The lid 12 can be composed of any suitable lightweight material, such as plastic.

The drainage collection box device 11 further comprises a fastening mechanism adapted to prevent the lid 12 from opening beyond the point that it would be unable to automatically return to the closed configuration once the water flow rate decreases. In the illustrated embodiment, the fastening mechanism is a cord 13 having a first end and a second end. The first end is secured to the container 14 and the second end is removably secured to the lid 12. The second end of the cord 13 is adapted to be detached from the lid in order to allow a user to access the interior of the container 14.

In the illustrated embodiment, the drainage collection box device 11 further comprises a pair of baffles 25 adapted to direct the flow of water and debris towards the front wall 26 of the container 14. Each baffle 25 comprises a planar section suspended perpendicularly from the sides 28, 29 of the lid 12. A first baffle 25 is disposed on the first side 28 of the lid 12 and a second baffle 25 is disposed on the second side 29 of the lid 12.

When the lid 12 is in an open configuration, the baffles 25 are adapted to cover the open space between the sides of the container 14 and the sides 28, 29 of the lid 12, thereby creating a channel in order to allow the water and debris to flow through the open space facing the front wall 26 of the container 14. In this way, the flow of water and debris can be directed to be removal at a designated area, such as onto a street or paved surface. Referring now to FIG. 3, there is shown a cross section of an embodiment of the drainage collection box device. In the closed configuration, the baffles 25 are disposed within the container 14 and rest flush against the lateral sidewalls 17 thereof. However, in other embodiments, the drainage collection box device 11 does not include a pair of baffles 25. In this way, the device 11 is adapted to allow water and debris to flow through the open space facing the sidewalls 17 and the front wall 26 of the container 14 when the lid 12 is in an open configuration.

In some embodiments, the baffles 25 are disposed on the upper end of the interior of the lateral sidewalls 17 of the container 14. The baffles 25 comprise an elongated section that extends inward and is perpendicular to the sidewalls 17. Furthermore, the baffles 25 are angled upwards towards the front wall 26. In this way, the flow of the water and debris will be directed towards the open space facing the front wall 26 for removal therefrom.

Referring now to FIG. 4, there is shown a perspective view of an embodiment of the drainage collection box device in use. In operation, the container 14 of the drainage collection box device 11 is positioned beneath the ground, wherein the openings 15 are connected to pipes disposed underground. The open upper end of the container 14 and lid 12 remain level with the ground. Furthermore, the drainage collection box device 11 is level with the ground so as to allow a user to perform tasks, such as mowing the lawn or playing in the yard, without any obstruction from the device 11.

Once the drainage collection box device 11 is installed within the ground, water and debris flow into the container 14 via the pipes. As water and debris fill the container 14, the water level rises until the lid 12 is forcibly moved to an open configuration. The baffles 25 prevent water and debris from leaving through the sides of the drainage collection box device 11 and water is directed toward the front of the container 14. In this way, a user is able to direct the removal on to pavement of other surface in order to avoid over saturation of grassy areas.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A drainage collection box device, comprising:
a container comprising a base, one or more sidewalls, and an open upper end, wherein said container is adapted to receive water and debris therein;
a lid pivotally secured to said open upper end of said container, wherein said lid is movable between an open configuration, such that said lid is disposed at an angle so as to allow for removal of said water and debris from said container, and a closed configuration, such that said lid is horizontally disposed on said container;
one or more openings disposed in said one or more sidewalls of said container, wherein said one or more openings are adapted to secure to a pipe of a drainage system in order to receive said water and debris therein.

2) The drainage collection box device of claim 1, wherein said lid comprises a plurality of grates.

3) The drainage collection box device of claim 1, wherein said lid is solid.

4) The drainage collection box device of claim 1, further comprising a fastening mechanism disposed between said container and said lid, such that said fastening mechanism limits the extent to which said lid can be opened.

5) The drainage collection box device of claim 4, wherein said fastening mechanism is a cord having a first end and a second end, wherein said first end is secured to said open upper end of said collection box and said second end is removably secured to said lid, such that said lid can partially open.

6) The drainage collection box device of claim 1, further comprising one or more baffles secured to said lid and extending into an interior of said container.

7) The drainage collection box device of claim 6, wherein said first baffle and said second baffle each comprise a shape so as to correspond to a shape of a side opening disposed between said container and said lid when said lid is in said open configuration.
